(19) United States
(12) Patent Application Publication
(10) Pub. No.: US 2019/0301366 A1
(43) Pub. Date: Oct. 3, 2019

(54) Turbocharger Having Sealing Surfaces Between A Nozzle Ring And A Turbine Housing

(71) Applicant: MAN Energy Solutions SE, Augsburg (DE)

(72) Inventors: Tobias WEISBROD, Augsburg (DE); Paul SCHORER, Offingen (DE); Lukás BOZEK, Pribyslavice (CZ); Jan REZANINA, Namest nad Oslavou (CZ); Björn HOSSBAC, Diedorf (DE)

(21) Appl. No.: 16/465,849

(22) PCT Filed: Aug. 28, 2017
(86) PCT No.: PCT/EP2017/071511

§ 371 Date: May 31, 2019

(30) Foreign Application Priority Data
Dec. 1, 2016 (DE) 10 2016 123 149.1

(51) Int. Cl. F02C 6/12

(52) U.S. Cl. CPC F02C 6/12; F01D 11/005

(57) ABSTRACT

A turbocharger, having a turbine and a compressor. The turbine has a turbine housing and a turbine rotor. The compressor has a compressor housing and a compressor rotor coupled to the turbine rotor by a shaft. The turbine and compressor housings are connected to a bearing housing in which the shaft is supported. The turbine and bearing housings are a flange of the turbine housing by a first section and covers a flange of the bearing housing by a second section. A flange of a nozzle ring is clamped between respective flanges of the turbine housing and the housing. Between the flange of the turbine housing and the flange of the nozzle ring, an axial sealing region is formed with scaling surfaces that lie against each other and one sealing surfaces has a contour deviating from a flat contour.

### CROSS REFERENCE TO RELATED APPLICATIONS

This is a U.S. national stage of application No. PCT/EP2017/071511, filed on Aug. 28, 2017. Priority is claimed on German Application No. DE102016123249.1, filed Dec. 1, 2016, the content of which is incorporated here by reference.

### BACKGROUND OF THE INVENTION

### 1. Field of the Invention

The invention relates to a turbocharger.

### 2. Description of the Prior Art

From DE 10 2013 002 605 A1, the fundamental construction of a turbocharger is known. A turbocharger comprises a turbine in which a first medium is expanded, a compressor, in which a second medium is compressed, namely utilising the energy extracted in the turbine during the expansion of the first medium, a turbine housing, and a turbine rotor. The compressor of the turbocharger comprises a compressor housing and a compressor rotor. Between the turbine housing of the turbine and the compressor housing of the compressor a bearing housing is positioned, wherein the bearing housing on the one side is connected to the turbine housing and on the other side to the compressor housing. In the bearing housing, a shaft is mounted via which the turbine rotor is coupled to the compressor rotor.

From practice it is known that the turbine housing of the turbine, namely a so-called turbine inflow housing, and the bearing housing are connected to one another via a fastening device which is preferentially designed as a clamping claw. Such a fastening device, which is preferentially designed as a clamping claw is mounted, with a first section of the same, to a flange of the turbine housing via fastners and, with a second section, covers a flange of the bearing housing at least in sections. By way of such a fastening device, the combination of bearing housing and turbine housing is braced, in particular while clamping a flange of a nozzle ring and if required a flange of a heat shield between the flange of the turbine housing and the flange of the bearing housing.

The turbine housing is filled with the first medium to be expanded, in particular with exhaust gas to be expanded. The turbine inflow housing of the turbine housing conducts the exhaust gas in the direction of the turbine rotor. In the turbine inflow housing there is a positive pressure relative to the surroundings, which in the turbine is removed subject to extracting energy during the expansion of the first medium. In the region of the connection of turbine housing or turbine inflow housing and bearing housing a leakage can occur, so that the first medium to be expanded in the turbine can enter the surroundings via the connecting region between turbine housing and bearing housing. This is disadvantageous.

To counteract leakage of the first medium to be expanded in the turbine, the bracing between turbine housing or turbine inflow housing and bearing housing is increased in practice, in particular via higher tightening torques for the fastners, via which the fastening device that is preferentially designed as clamping claw is mounted to the turbine housing. This also increases a clamping force between the fastening device and the bearing housing. A contact point between the bearing housing and the fastening device is exposed to high relative movements as a consequence of different thermal expansions of bearing housing and turbine housing or turbine inflow housing.

### SUMMARY OF THE INVENTION

An object of one aspect of the present invention is a new type of turbocharger with an improved flange connection.

According to one aspect of the invention, an axial sealing region between axial sealing surfaces of the flanges of turbine housing and nozzle ring lying against one another is formed between the flange of the turbine housing and the flange of the nozzle ring, which is clamped between the flange of the turbine housing and the flange of the bearing housing, wherein at least one of these axial sealing surfaces has a contour that deviates from a flat contour.

By way of this, a particularly advantageous sealing of the connecting point of turbine housing or turbine inflow housing and bearing housing is possible. The risk that medium to be expanded in the turbine enters the surroundings via the connecting region between turbine housing and bearing housing is reduced.

According to an advantageous first further development of the invention, both axial sealing surfaces have a contour that deviates from a flat contour. Preferentially, a projection is formed on the axial sealing surface of the flange of the nozzle ring that engages in a recess in the axial sealing surface of the flange of the turbine housing. Alternatively, a projection can also be formed on the axial sealing surface of the flange of the turbine housing, which engages in a recess in the axial sealing surface of the flange of the nozzle ring. The projection and the recess form a labyrinth seal. During different thermal expansions of bearing housing and turbine housing or turbine inflow housing and nozzle ring, the projection presses into the recess and reinforces the sealing effect of the formed labyrinth seal. The risk that medium to be expanded in the turbine enters the surroundings via the connecting region between turbine housing and bearing housing is reduced.

According to a second alternative further development of the invention, exclusively one of the two axial sealing surfaces has a contour that deviates from a flat contour whereas the other one of the two axial sealing surfaces has a flat contour. Preferentially, the axial sealing surface of the flange of the turbine housing is then convexly curved to the outside in the direction of the axial sealing surface of the flange of the nozzle ring that is contoured flat. Alternative, the axial sealing surface of the flange of the nozzle ring can also be convexly curved to the outside in the direction of the sealing surface of the flange of the turbine housing that is contoured flat. During different thermal expansions of bearing housing and turbine housing or turbine inflow housing and nozzle ring, in particular during thermal deformation of the nozzle ring, a good sealing effect can be ensured in the connecting region between turbine housing and bearing housing. The risk that medium to be expanded in the turbine enters the surroundings via the connecting region between turbine housing and bearing housing is reduced.

### BRIEF DESCRIPTION OF THE DRAWINGS

Preferred further developments of the invention are obtained from the subclaims and the following description. Exemplary embodiments of the invention are explained in more detail by way of the drawing without being restricted to this.

There it shows:

FIG. 1: is a cross section by way of an extract through a turbocharger in a region of a connection of a turbine housing to a bearing housing; and

FIG. 2: is a cross section by way of an extract through a turbocharger in a region of a connection of a turbine housing to a bearing housing.

### DETAILED DESCRIPTION OF THE PRESENTLY PREFERRED EMBODIMENTS

The invention relates to a turbocharger.

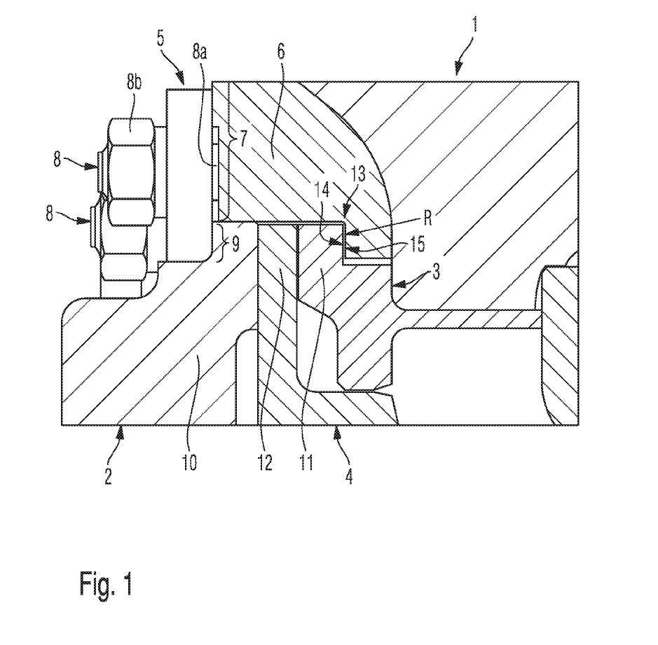

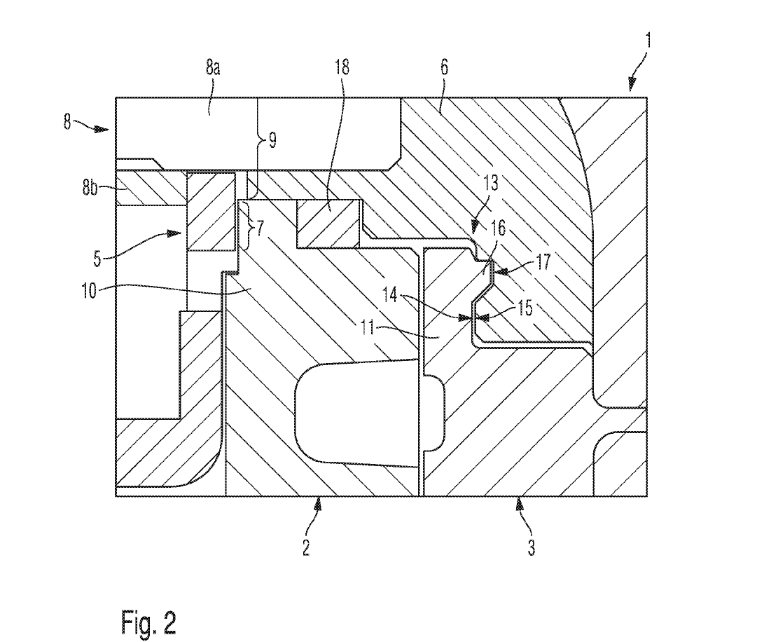

A turbocharger comprises a turbine for expanding a first medium, in particular for expanding exhaust gas of an internal combustion engine and a compressor for compressing a second medium, in particular charge air, namely utilising energy extracted in the turbine during the expansion of the first medium. Here the turbine comprises a turbine housing and a turbine rotor. The compressor comprises a compressor housing and a compressor rotor. The compressor rotor is coupled to the turbine rotor via a shaft, which is mounted in a bearing housing, wherein the bearing housing is positioned between the turbine housing and the compressor housing and connected both to the turbine housing and to the compressor housing. The person skilled in the art addressed here is familiar with this fundamental construction of a turbocharger. One aspect of the invention relates to such details of a turbocharger which relate to the connection of turbine housing of a turbine preferentially designed as a radial turbine and bearing housing of a turbocharger. In the following, making reference to FIGS. 1 and 2, different exemplary turbochargers are described, wherein FIGS. 1 and 2 each show relevant extracts from a turbocharger in the region of the connection of the turbine housing to the bearing housing.

A first exemplary embodiment of a turbocharger is shown by FIG. 1. In FIG. 1 the connecting point between a turbine housing, namely a turbine inflow housing 1 of the turbine housing and a bearing housing 2 of the exhaust gas turbocharger is shown. FIG. 1, furthermore, shows a nozzle ring 3 and a heat shield 4. The turbine inflow housing 1 is connected to the bearing housing 2 via a fastening device 5 such that the fastening device 5 is mounted to a flange 6 of the turbine inflow housing 1 with a first section 7, namely via multiple fasteners 8, and that the fastening device 5 with a second section 9 covers a flange 10 of the bearing housing 2 at least in sections. The fastening device 5 is also referred to as clamping claw and braces the turbine inflow housing 1 and the bearing housing 2 with one another. The fastening device 5 can be segmented seen in the circumferential direction.

In the exemplary embodiment shown in FIGS. 1 and 2, each fastener 8 comprises a threaded screw 8a screwed into the flange 6 of the turbine inflow housing 1 and a nut 8b acting on the other end of the threaded screw 8a, wherein by tightening the nuts 8b a defined preload force can be exerted on the turbine inflow housing 1 and the bearing housing 10 via the fastening device 5. In the process, a flange 11 of nozzle ring 3 and a flange 12 of the heat shield 4 are clamped between the flange 6 of turbine inflow housing 1 and the flange 10 of the bearing housing 2.

In the turbocharger of FIG. 1, it is provided for sealing the connecting region between turbine inflow housing 1 and bearing housing 2 that between the flange 6 of the turbine inflow housing 1 and the flange 11 of the nozzle ring 3 an axial sealing region 13 is formed between axial sealing surfaces 14, 15 of the flanges 6, 11 of turbine housing 1 and nozzle ring lying against one another. At least one of these axial sealing surfaces 14, 15, i.e. the axial sealing surface 14 of the flange 11 of the nozzle ring 3 and/or the axial sealing surface 15 of the flange 6 of the turbine inflow housing 1, has a contour that deviates from a flat contour. By way of this, a particularly advantageous sealing of the connecting region between turbine inflow housing 1 and bearing housing 2 can be provided during a different thermal expansion of turbine inflow housing 1, bearing housing 2 and nozzle ring 3, namely in the region of the axial sealing region 13 between turbine inflow housing 1 and nozzle ring 3.

In FIG. 1, one of the two axial sealing surfaces 14, 15 has a contour that deviates from a flat contour, whereas the other one of the two axial sealing surfaces 15 or 14 has a flat contour. Preferentially, that sealing surface 14, 15 which has a contour that deviates from the flat contour is convexly curved to the outside in the direction of the other axial sealing surface that is contoured flat.

In FIG. 1, the sealing surface 15 on the flange 6 of the turbine inflow housing 1 is convexly curved to the outside in the direction of the axial sealing surface 14 of the flange 11 of the nozzle ring 3 that is contoured flat, namely with the curvature radius R. Although not preferred it is also possible to alternatively provide such a curvature radius on the sealing surface 14 of the flange 11 of the nozzle ring 3, which is then convexly curved to the outside in the direction of the axial sealing surface of the flange 6 of the turbine inflow housing 1 which is then contoured flat.

FIG. 1 is based on the realisation that during the operation the nozzle ring 3 is thermally deformed and because of this the surface pressure necessary for the sealing between nozzle ring 3 and turbine inflow housing 1 can no longer be maintained. The thermal deformation of the nozzle ring is specifically utilised by the convex curvature in particular of the sealing surface 15 of the flange 6 of the bearing housing 1 namely in such a manner that on this convexly curved sealing surface 15 of the flange 6 of the turbine inflow housing 1 the sealing surface 14 of the flange 11 of the nozzle ring 3 can roll itself, by way of which a continuous linear contact between the sealing surfaces 14, 15 of the flanges 6, 11 of turbine housing 1 and nozzle ring 3 facing one another can then be ensured so that there is no risk that exhaust gas enters the surroundings via this connecting region.

The turbocharger of FIG. 2 differs from the turbocharger of FIG. 1 in particular in that in the turbocharger shown in FIG. 2 exclusively the flange 11 of the nozzle ring 3 is clamped between the flange 10 of the bearing housing 2 and the flange 6 of the turbine inflow housing 1, but not as in FIG. 1 the heat shield 4 with its flange 12.

A further distinction between FIG. 2 and FIG. 1 consists in that in FIG. 2 both axial sealing surfaces 14, 15 of the flanges 6, 11 of turbine inflow housing 1 and nozzle ring 3 have a contour that deviates from a flat contour.

Accordingly it is provided in FIG. 2 that on the axial sealing surface 14 of the flange 11 of the nozzle ring 3 a projection 16 is formed which engages in a corresponding recess 17 in the axial sealing surface 15 of the flange 6 of the turbine inflow housing 1. The projection 16 is contoured lug-like in the cross section and is circumferential. By the inter-engaging of the projection 16 in the circumferential recess 17 a type of labyrinth seal is formed. During different thermal expansion of turbine inflow housing 1, nozzle ring 3 and bearing housing 2, the projection 16 is pressed into the groove 17 and reinforce the sealing effect in the axial sealing region 13.

Although not preferred it is also possible to provide the projection 16 provided in FIG. 2 on the sealing surface 14 of the flange 11 of the nozzle ring 3 in the region of the sealing surface 15 of the flange 6 of the turbine inflow housing 1, wherein in this case the correspondingly contoured recess is then formed on the sealing surface 14 of the flange 11 of the nozzle ring 3.

In the exemplary embodiment of FIG. 2, a further sealing element 18 is arranged between the flange 10 of the bearing housing 2 and the flange 6 of the turbine inflow housing 1 in order to further seal the connecting region between turbine inflow housing 1 and bearing housing 2. This is preferentially a metallic sealing element 18, for example a metallic O-ring or a metallic C-ring. Furthermore, the sealing element 18 can also consist of graphite.

The sealing element 18 of FIG. 2, which is positioned between the flanges 6, 10 of turbine inflow housing 1 and bearing housing 2 and seals both in the axial and also in the radial direction, can also be employed with the turbocharger of FIG. 1.

Both exemplary embodiments of FIGS. 1 and 2 have in common that between the flange 6 of the turbine inflow housing 1 and the flange 11 of the nozzle ring 3 the axial sealing region 13 is formed, in which axial sealing surfaces 14, 15 of the flanges 6, 11 of turbine inflow housing 1 and nozzle ring lie against one another. In particular, a metallic surface contact exists between these axial sealing surfaces 14, 15. At least one of these axial sealing surfaces 14, 15 of the flanges 6, 11 of turbine inflow housing 1 and nozzle ring 3 has a contour that deviates from a flat contour. Particularly preferred is the version of FIG. 2, in which both axial sealing surfaces 14, 15 have a contour that deviates from the flat contour, namely such that a circumferential projection formed on the axial sealing surface 14 of the flange 11 of the nozzle ring 3 engages in a correspondingly contoured recess 17, which is introduced into the sealing surface 15 of the flange 6 of the turbine inflow housing 1.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-10. (canceled)

11. A turbocharger, comprising:
a turbine configured to expand a first medium comprising:
a shaft;
a turbine housing; and
a turbine rotor;
a compressor configured to compress a second medium utilising energy extracted in the turbine during expansion of the first medium, comprising:
a compressor housing; and
a compressor rotor coupled to the turbine rotor via the shaft,
a bearing housing in which the shaft is mounted and arranged between and connected to the turbine housing and the compressor housing;
a fastening device that connect the turbine housing and the bearing housing, the fastening device is mounted to a flange of the turbine housing with a first section and with a second section covers a flange of the bearing housing at least in sections;
at least one flange of a nozzle ring is clamped between the flange of the turbine housing and the flange of the bearing housing;
an axial sealing region is formed between the flange of the turbine housing and the flange of the nozzle ring by axial sealing surfaces of the respective flanges lying against one another,
wherein at least one of the axial sealing surfaces has a contour that deviates from a flat contour.

12. The turbocharger according to claim 11, wherein both axial sealing surfaces have a contour that deviates from a flat contour.

13. The turbocharger according to claim 11, wherein on the axial sealing surface of the flange of the nozzle ring a projection is formed that engages in a recess in the axial sealing surface of the flange of the turbine housing.

14. The turbocharger according to claim 11, wherein on the axial sealing surface of the flange of the turbine housing a projection is formed that engages in a recess in the axial sealing of the flange of the nozzle ring.

15. The turbocharger according to claim 13, wherein the projection and the recess form a labyrinth seal.

16. The turbocharger according to claim 11, wherein only one of the two axial sealing surfaces has a contour that deviates from a flat contour and the other one of the two axial sealing surfaces has a flat contour.

17. The turbocharger according to claim 16, wherein the axial sealing surface of the flange of the turbine housing is convexly curved to an outside in a direction of the axial sealing surface of the flange of the nozzle ring that is contoured flat.

18. The turbocharger according to claim 16, wherein the axial sealing surface of the flange of the nozzle ring is convexly curved to an outside in a direction of the axial sealing surface of the flange of the turbine housing that is contoured flat.

19. The turbocharger according to claim 11, wherein the axial sealing surfaces of the flange of the turbine housing and of the flange of the nozzle ring lying against one another are in metallic surface contact.

20. The turbocharger according to claim 11, wherein the turbine is a radial turbine.

21. The turbocharger according to claim 14, wherein the projection and the recess form a labyrinth seal.
